(19) United States
(12) Patent Application Publication
(10) Pub. No.: US 2024/0378636 A1
(43) Pub. Date: Nov. 14, 2024

(54) Asset Audience Gap Recommendation and Insight

(71) Applicant: Google LLC, Mountain View, CA (US)

(72) Inventors: Charles Baxter Boyd, Santa Clara, CA (US); Simon Andreas Witzel, Brooklyn, NY (US)

(21) Appl. No.: 18/659,977

(22) Filed: May 9, 2024

Related U.S. Application Data
(60) Provisional application No. 63/501,191, filed on May 10, 2023.

(51) Int. Cl. G06Q 30/0242

(52) U.S. Cl. CPC G06Q 30/0245

(57) ABSTRACT

Techniques for determining an audience gap for a communication campaign presented herein. The system can obtain data indicating a content item for a communication campaign of a client account. The system can determine, based on the attribute, that the content item is associated with a first group type. The first group type can include a plurality of audience segments. Additionally, the system can determine, using performance data of the communication campaign of the client account, a first performance value of a first audience segment in the plurality of audience segments. Moreover, the system can determine, based on the first performance value transcending a performance threshold value, that the content item has an audience gap associated with the first audience segment. Furthermore, the system can perform an action based on the determination that the content item has the audience gap associated with the first audience segment.

### PRIORITY

The present application claims the benefit of priority of U.S. Provisional Patent Application No. 63/501,191, filed on May 10, 2023, which is incorporated by reference herein.

### FIELD

The present disclosure relates generally to automatically generating content items or media assets using generative machine-learned models based on an audience gap in a communication campaign.

### BACKGROUND

A communication campaign can leverage a multi-modal, multi-platform distribution system to distribute content items to various endpoints for various audiences. The content items can be or include media assets. A user can create a communication campaign by providing the multi-modal, multi-platform distribution system with a set of content items for distribution.

In a conventional system, a user may struggle to know how to improve their communication campaign. Additionally, the user may not be able to determine what makes a good asset for the types of consumers that are likely to convert for their product or service. Moreover, a conventional content serving system cannot determine audience gaps in a communication campaign. The determination of audience gaps can improve communication campaigns by ensuring that the content items are relevant to the specific users.

### SUMMARY

Aspects and advantages of embodiments of the present disclosure will be set forth in part in the following description, or can be learned from the description, or can be learned through practice of the embodiments.

One example aspect of the present disclosure is directed to a computing-implemented method. The method can include obtaining data indicating a content item for a communication campaign of a client account, the content item having an attribute. Additionally, the method can include determining, based on the attribute, that the content item is associated with a first group type (e.g., running shoes, travel service, vehicle, food). The first group type can include a plurality of audience segments (e.g., green living enthusiasts, thrill seekers, foodies, recently graduated). Additionally, the method can include determining, using performance data of the communication campaign of the client account, a first performance value of a first audience (e.g., foodies) segment in the plurality of audience segments. For example, the content item can be a box of chocolate, and the first audience segment can be individuals who are food lovers. The first performance value can be a click-through rate (CTR) for food lovers. Moreover, the method can include determining, based on the first performance value transcending a performance threshold value, that the content item has an audience gap associated with the first audience segment. For example, the first performance value can be below the performance threshold value, which can indicate that the communication campaign for the box of chocolate has an audience gap with food lovers. Subsequently, the method can include performing an action based on the determination that the content item has the audience gap associated with the first audience segment.

In some instances, the method can further include determining, based on performance data of a plurality of similar accounts, a set of features in content items that are presented to the first audience segment. Additionally, the set of features can improve a performance metric of the content items that are presented to the first audience segment. Moreover, the action performed when determined that the content item has the audience gap can be based on the set of features. For example, the system can determine that images of mountains can improve the CTR for green living enthusiasts, and the action performed can be to modify the content item to include an image of a mountain. In another example, the system can determine, based on performance data of content items viewed by the first audience segment, a set of features in the content items that are presented to the first audience segment. The content items viewed by the first audience segment can be from any content provider to ensure that the system has enough data for a confident assessment.

In some instances, the plurality of similar accounts is determined based on each account in the plurality of similar accounts having a similarity score that exceeds a similarity threshold value. The similarity score can be derived based on a search query similarity between the client account and the similar account. For example, the client account and the similar account can have a high similarity score if both accounts are associated with the “running” keyword search term.

In some instances, each similar account in plurality of similar accounts have a similar geolocation as the client account.

In some instances, the client account includes a media asset profile. The method can further include comparing a first feature in the set of features and the media asset profile. Additionally, the method can include generating, based on the comparison of the first feature and the media asset profile, a subset of features by removing the first feature from the set of features. Moreover, the action performed when determined that the content item has the audience gap can be based on the subset of features.

In some instances, the comparison of the first feature and the media asset profile includes processing the first feature, using a machine-learned model, to generate feature embeddings. Additionally, the method can include processing assets in the media asset profile, using the machine-learned model, to generate profile embeddings. Moreover, the method can include comparing the feature embeddings and the profile embedding to determine that the first feature does not correspond to assets in the media asset profile. For example, the client account can be associated with travel to the mountains, and the first feature can be an image of a beach. The method can determine that the beach is not associated with the client account and remove this feature from the set of features. In another example, the system can remove the first feature from the set of features when the system determines that similar accounts (e.g., content providers that are similar to the client account) do not include (e.g., present the first feature) in their content items. For example, the first feature can be an image of a beach, but none of the content items of similar accounts include an image of the beach, thus the system will remove the first feature from the set of features.

In some instances, the method can include processing a plurality of content items associated with the first group type, using a machine-learned model, to determine the plurality of audience segments. For example, the first group type can be running shoes, and the plurality of audience segments can include athletes, students, elderly, children, and so on. In some instances, a performance value of each audience segment in the plurality of audience segments exceeds a threshold value.

In some instances, the method can include generating, using a machine-learned asset generation pipeline, a suggested asset based on the first audience segment. Additionally, the action performed can also include a presentation of the suggested asset on a graphical user interface of the client account. In some instances, the suggested asset is generated when the client account includes an audience segment. For example, if the system determines that the client account is not associated with any audience segment, then the system does not present a suggested asset on the graphical user interface.

In some instances, the client account can include a media asset profile. Additionally, the suggested asset is generated using the machine-learned asset generation pipeline further based on the media asset profile of the client account. For example, the suggested asset can be generated based on a pre-existing asset associated with the client account. The pre-existing asset can be previously uploaded to the client account.

In some instances, the method can include processing the suggested asset and the first audience segment, using a machine-learned estimation model, to determine an uplift estimation value. Additionally, the action performed further includes the presentation of the uplift estimation value on the graphical user interface. In another example, the uplift estimation can be determined using a manually created heuristic model.

In some instances, the machine-learned estimation model can be trained on performance data of a plurality of similar accounts.

In some instances, the first performance value can be a click-through rate, and the threshold value can be an average click-through rate for the first audience segment.

In some instances, the first group can be a type of product.

In some instances, the content item can be currently being served in the communication campaign.

One or more non-transitory, computer readable media storing instructions that are executable by one or more processors to cause a computing system to perform operations, the operations comprising the method of any of the preceding claims.

In one example aspect, the present disclosure provides for a computing system. The computer system includes one or more processors, and one or more transitory or non-transitory computer-readable media storing instructions that are executable to cause the one or more processors to perform operations. The operations can include obtaining data indicating a content item for a communication campaign of a client account, the content item having an attribute. Additionally, the operations can include determining, based on the attribute, that the content item is associated with a first group type. The first group type can include a plurality of audience segments. Additionally, the operations can include determining, using performance data of the communication campaign of the client account, a first performance value of a first audience segment in the plurality of audience segments. Moreover, the operations can include determining, based on the first performance value transcending a performance threshold value, that the content item has an audience gap associated with the first audience segment. Subsequently, the operations can include performing an action based on the determination that the content item has the audience gap associated with the first audience segment.

In some instances, the present disclosure provides for example a transitory or non-transitory computer readable medium embodied in a computer-readable storage device and storing instructions that, when executed by a processor, cause the processor to perform operations. In the example transitory or non-transitory computer-readable medium, the operations include obtaining data indicating a content item for a communication campaign of a client account, the content item having an attribute. Additionally, the operations can include determining, based on the attribute, that the content item is associated with a first group type. The first group type can include a plurality of audience segments. Additionally, the operations can include determining, using performance data of the communication campaign of the client account, a first performance value of a first audience segment in the plurality of audience segments. Moreover, the operations can include determining, based on the first performance value transcending a performance threshold value, that the content item has an audience gap associated with the first audience segment. Subsequently, the operations can include performing an action based on the determination that the content item has the audience gap associated with the first audience segment.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example machine-learned media asset generation system according to example embodiments of the present disclosure.

FIG. 2 depicts a flow diagram of an example process for generating suggested assets according to example embodiments of the present disclosure.

FIG. 3 depicts a block diagram of an example system for generating media assets based on a web resource of a client account according to example embodiments of the present disclosure.

FIG. 4 depicts a flow chart diagram of an example technique for determining an audience gap in a communication campaign according to embodiments of the present disclosure.

FIG. 5 depicts a flow chart diagram of an example technique for determining an audience gap and generating a suggested asset for the audience gap example according to embodiments of the present disclosure.

FIG. 6 depicts a flow chart diagram of an example technique for generating a suggested asset for the audience gap and calculating an estimation uplift value example according to embodiments of the present disclosure.

FIG. 7 depicts an example graphical user interface of a communication campaign platform according to embodiments of the present disclosure.

FIG. 8 depicts an example graphical user interface of a communication campaign platform according to embodiments of the present disclosure.

FIG. 9 depicts an example graphical user interface of a communication campaign platform according to embodiments of the present disclosure.

FIG. 10 is a flow chart diagram illustrating an example method for training a machine-learned model according to example implementations of aspects of the present disclosure;

FIG. 11 is a block diagram of an example processing flow for using machine-learned model(s) to process input(s) to generate output(s) according to example implementations of aspects of the present disclosure;

FIG. 12 is a block diagram of an example sequence processing model according to example implementations of aspects of the present disclosure;

FIG. 13 is a block diagram of an example technique for populating an example input sequence for processing by a sequence processing model according to example implementations of aspects of the present disclosure;

FIG. 14 is a block diagram of an example model development platform according to example implementations of aspects of the present disclosure;

FIG. 15 is a block diagram of an example training workflow for training a machine-learned model according to example implementations of aspects of the present disclosure;

FIG. 16 is a block diagram of an inference system for operating one or more machine-learned model(s) to perform inference according to example implementations of aspects of the present disclosure;

FIG. 17 is a block diagram of an example networked computing system according to example implementations of aspects of the present disclosure;

FIG. 18 is a block diagram of an example computing device according to example implementations of aspects of the present disclosure; and

FIG. 19 is a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to detecting an asset audience gap for a campaign and generating a media asset for the detected audience gap. In some instances, an asset audience gap can occur when media assets (e.g., visual assets) are not appealing to one or more valuable audiences for a campaign. For each gap, the system, using a machine-learned model, can provide an asset gap recommendation for an asset or a content item that can resonate better with the audience associated with the asset audience gap. The asset gap recommendation provides relevant and actionable recommendations by optimizing the content items presented to users. For example, the system can present a content item with an uplift estimate. A content item (e.g., visual creative) can be served to users on a webpage, application, or other digital environment. A content item can include a plurality of assets (e.g., images, videos, audio, and other formats that get delivered to users). Additionally, when a user enables image asset automation, the system can automatically incorporate the asset gap recommendations in a communication campaign.

The asset audience gap can identify an audience gap (e.g., valuable traffic slice) and an opportunity to increase value of a communication campaign by tailoring to the audience gap. In some instances, various possible audience segmentations (e.g., traffic segmentations) can be used to determine the asset audience gap.

According to some embodiments, the asset audience gap can be determined by determining a set of valuable traffic slices. The set of valuable traffic slices can be overlapping and/or multi-attributed. Additionally, the system can determine how to detect if a given asset is tailored to a given slice. Moreover, the system can generate new tailored assets that can resonate with the given traffic slice. Subsequently, the system can calculate a performance impact resulting from adding the new tailored assets to the communication campaign.

For example, the system can present to a user a notification stating, “your important traffic slice X has no assets tailored to it-try adding some.” Additionally, the system can generate a plurality of new tailored assets and present to the user a second notification stating, “and by the way, traffic slice X responds well to images of Y.” Moreover, the system can calculate a performance impact associated with adding the new tailored assets to the communication campaign and present a third notification stating, “in fact, they are Z % more likely to click on images of Y.”

The system determines an audience gap for a content item based on performance data of previous communication campaigns that may have similar products or services. The audience gap for a content item can highlight audiences that are interested in the offered product or service but are not clicking on the content item in the campaign. First, the system generates a plurality of audience segments based on each audience segment's performance (e.g., interaction rate) at a campaign level. The system determines which of these audience segments interacts with any asset in the campaign below a threshold value to establish an audience asset gap for a campaign. For example, the threshold value can be the amount of interaction for an average person. The system can determine top audience segments based on a plurality of metrics at the campaign level (e.g., impressions, clicks, conversions, and conversion value). The system can also group by asset, then shows the top audiences for each asset by using an interaction rate. By using performance data to identify gaps and automatically fill them, the system enables the creation and presentation of visual creative that is uniquely relevant to each impression.

Additionally, the system aggregates data across customers to determine a content suggestion (e.g., visual suggestion) and an estimate of uplift. The content suggestion can include a visual asset that performs best for each audience segment, along with a correlative estimate of uplift by including these visual assets. In some instances, for certain audience segments, the system can further slice the content suggestions by dimensions such as product, service, and/or region. The asset gap insight can include the audience asset gap, the content suggestion, and an estimate of uplift.

Subsequently, the audience asset gap is inputted into a machine-learned model to curate and rank a set of image suggestions that may help fill this audience gap. In some embodiments, when the system is successful in producing at least one image, then the image is surfaced in a new asset audience gap recommendation. In some embodiments, when the system is unsuccessful in sourcing a recommended image, the system encourages users to manually add more assets. While the current implementation is focused primarily on image assets, these techniques can be extended to video and text assets.

The system can train and utilize machine-learned models to analyze audience demographics, behavior, and preferences, allowing for improved targeting of content. This leads to increased relevance of content to users, maximizing the effectiveness of campaigns.

The system can dynamically generate creatives tailored to specific audience segments based on their interests, previous interactions, and contextual factors. This ensures that the generated content is highly engaging and relevant, improving user engagement and conversion rates.

The system, using a machine-learning model, can determine an audience gap. An audience gap can be defined as valuable audience for a communication campaign which does not have an asset of a particular type (e.g., image) with an interaction rate that is above a threshold value (e.g., Y multiplier of an average value for an audience segment) for that audience within the communication campaign.

For example, the system can define a valuable audience as an audience that has either: A >W multiplier on conversion value over the average; A >Y multiplier on conversions over the average; or A >Z multiplier on interaction rate over the average. The X, Y, Z, and W thresholds (e.g., 1.5×) can be specified in a quality refinement process. In some instances, Z (for interaction rate) can be notably higher than Y and W (for conversions). For example, when the system does not have sufficient conversion performance for statistical significance, then the system can analyze interaction rate for valuable audiences. The audience interaction rate multiplier can be higher than the conversion rate multiplier to ensure the audience is actually valuable. An audience gap can still happen for interaction rates because the valuable audiences can be determined at the campaign level (which includes inventory without images, for example), while gaps are determined when looking at the asset level. Based on the asset audience gap, the system can present audience hints that can highlight to a customer an audience segment that can be valuable but is not performing well based on the current assets.

According to some embodiments, the system generates content suggestions and uplift estimation. The system can determine the types of content of an asset (e.g., content of an image) that is appealing to users in each audience. The system can label assets (e.g., image assets) used in communication campaigns globally with content labels. Then the system can find the types of labels that tend to perform well (via our target metric) for a given audience. For each label, the system can track a correlative uplift that the label generally provides compared to when the label is omitted for the specific audience.

In some cases, grouping by audience only can be insufficient with regards to the amount of data (e.g., for statistical significance). As part of the engineering quality tuning, the system can further slice either all or specific types of audiences by vertical, product/service, and/or region. This allows us to create a mapping of audience to content labels (or audience+optional additional slicing to content label), subject to the safety described below.

To improve latency, the mapping of each group can be determined offline, and the mapping can be periodically (e.g., every week) updated. Once an audience gap is identified, the—system can retrieve (e.g., look-up) the content labels in the mapping and surface them to users as suggestions for asset content to close the gap. However, the system may not surface a label if any enabled asset in the communication campaign is determined to already have that content. For example, the system can determine that a first label (e.g., a mountain) performs well with a first group (e.g., outdoor lovers), but if a content item in the communication campaign already includes the first label, then the first label is not suggested to the user.

According to some embodiments, the system can determine an uplift estimation of the suggested asset. For example, prior to presenting the suggested asset to a user, the system can determine an uplift estimate. The uplift estimate can be a percentage improvement of the current communication campaign. In some instances, the system can convert the uplift estimate to an interaction and/or conversion rate and present the interaction and/or conversion rate.

The system can include a target metric. For example, the system can use interaction rate as the target metric. The interaction rate can be based on long clicks per impression rate (“long CTR”). Thus, the system can present uplift estimates to users by making an estimate of conversion uplift as a result of the long CTR change. In another embodiment, the interaction rate can be based on a clickthrough rate (CTR). CTR can be used to gauge how well a content item is performing in a communication campaign. CTR can be the number of clicks that the content item receives divided by the number of times the content item is shown (i.e., clicks÷impressions=CTR). For example, if the content item had 5 clicks and 100 impressions, then the CTR of the content item is 5%. In yet another embodiment, the target metric can be conversions or conversion rate.

The system can generate a suggested asset (e.g., suggested image) for the audience asset gap. The audience asset gap information, communication campaign information, and client account information can be processed by a machine-learned model to generate suggested assets. The system can recommend the suggested assets to users in a current communication campaign. For example, the system can recommend specific images to fill an asset audience gap for a communication campaign based on the suggested content labels.

In some instances, the suggested asset can be generated based on a ranking signal for recommending new assets. The recommended new assets can be from any source, including assets that are obtained or derived from the client account. Additionally, the suggested asset can be generated based on an input for adapting or generating assets, such as background replacement or generating lifestyle imagery based on product imagery.

The system can generate the content labels by performing an asset group mapping for a communication campaign. In some instances, given that the mapping data is at a campaign-level, the system can recommend adding an asset to the asset group based on a relevance score to the suggested asset. For example, the recommendation can be to asset an asset with the relevance score above a threshold value. For example, the relevance score can be calculated by comparing the suggested asset to client information of the client account. The client information can include a headline of the client account, a description of the client account, landing page information of the client account, or webpage information of the client account (e.g., assuming unique pages among asset groups in the campaign).

In some instances, when the target asset group has a threshold number of media (e.g., image) assets already, the system can consider the next-nearest asset group for the suggested asset. In some instances, if all asset groups in the communication campaign have reached a maximum number of image assets, then the system can suppress the image recommendations.

According to some embodiments, the system can generate and present a suggested asset recommendation that can be triggered when a communication campaign has an asset audience gap. For example, the suggested asset recommendation that is presented can include an asset audience gap, one or more suggested labels for each asset audience gap, and/or one or more suggested media asset for each audience gap. The suggested media asset can be an image asset, a video asset, an audio asset, or a text asset. In some instances, when the system cannot determine at least one content suggestion, the recommendation can be suppressed by the system.

Additionally, the system can present an estimation of conversion uplift from applying the suggested media asset. Moreover, in some instances, instead of or in combination with the suggested media asset, the system can prompt the user to edit one or more asset groups manually.

Examples of the disclosure provide several technical effects, benefits, and/or improvements in computing technology and artificial intelligence techniques that involve the use of machine learning algorithms to determine an audience gap and generate new media assets (e.g., images, audio, text, video, or other types of media) for the audience gap. The system trains and utilizes machine-learned models to analyze audience demographics, behavior, and preferences, allowing for improved targeting of content. This leads to increased relevance of content to users, maximizing the effectiveness of campaigns. The system dynamically generates creatives tailored to specific audience segments based on their interests, previous interactions, and contextual factors. This ensures that the generated content is highly engaging and relevant, improving user engagement and conversion rates. The techniques described herein improve the use of generative models by improving the quality of the generated content. The quality of the generated content can be tailored specifically to the entity (e.g., company, user) by using data extracted from a web resource of the entity. Additionally, the quality of the generated content can be tailored specifically to an audience asset gap by aggregating data from communication campaigns of similar content items. For example, by using more content-relevant data, the system improves the performance (e.g., clickthrough rate, conversions) of content generated generative models. Moreover, the system utilizes better training techniques by developing more efficient and effective training techniques that are specific to the entity (e.g., based on data extracted from a web resource of the entity) to reduce the time and resources required to train models. Furthermore, the system can incorporate user feedback and provide the feedback, via reinforcement learning or active learning, to generative models that can help the models learn from user preferences and improve over time. The present disclosure can reduce processing by reducing the number of manual inputs provided by a user and by reducing the number of interface screens which must be obtained, loaded, interacted with, and updated. For example, the user may only have to input a web address of a website, and the system can automatically extract content from the website and automatically generate content items for the user.

With reference now to the Figures, example embodiments of the present disclosure will be discussed in further detail.

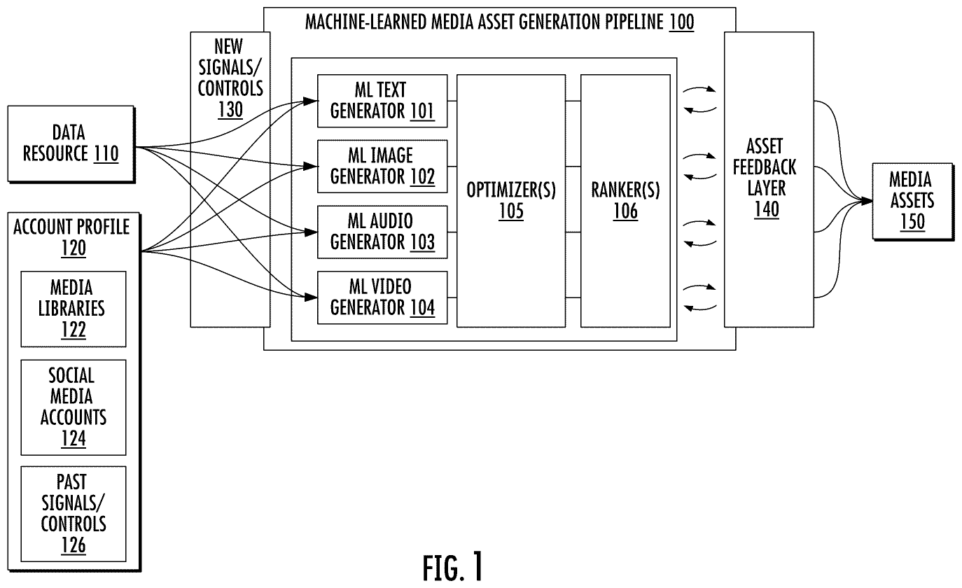

FIG. 1 depicts an example system for implementing a machine-learned media asset generation pipeline 100. Machine-learned media asset generation pipeline 100 can include a machine-learned text generator 101. Machine-learned media asset generation pipeline 100 can include a machine-learned image generator 102. Machine-learned media asset generation pipeline 100 can include a machine-learned audio generator 103. Machine-learned media asset generation pipeline 100 can include a machine-learned video generator 104. Machine-learned media asset generation pipeline 100 can include one or more optimizer(s) 105 to apply one or more optimization algorithms to the outputs of any one or more of machine-learned generator models 101 to 104. Machine-learned media asset generation pipeline 100 can include one or more ranker(s) 106 to rank outputs of any one or more of machine-learned generator models 101 to 104.

Machine-learned media asset generation pipeline 100 can ingest data from a data resource 110 and data from an account profile 120. Account profile 120 can include media asset preferences. Account profile 120 can include media libraries 122. Account profile 120 can include social media accounts 124. Account profile 120 can include past signals/controls 126 input to the machine-learned media asset generation pipeline 100. Machine-learned media asset generation pipeline 100 can process the data retrieved from data resource 110 and account profile 120 according to new signals/controls 130. New signals/controls 130 can include user inputs customizing the media asset generation.

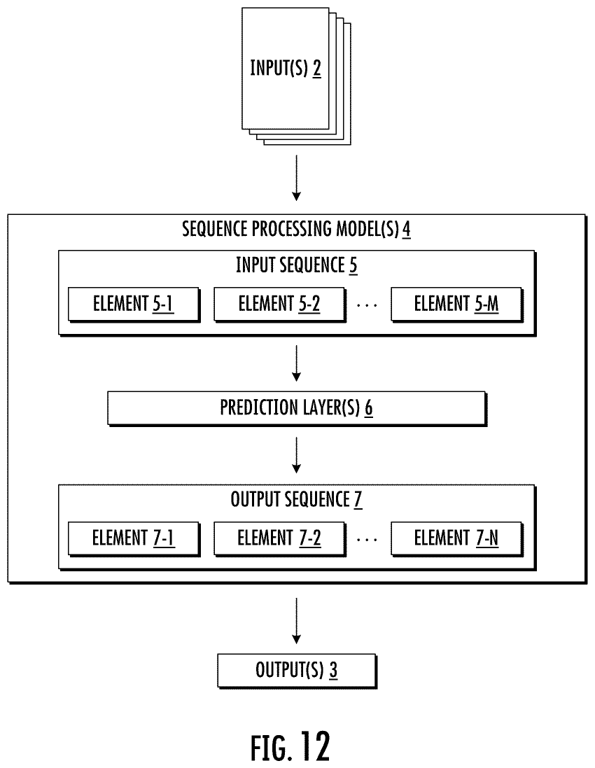

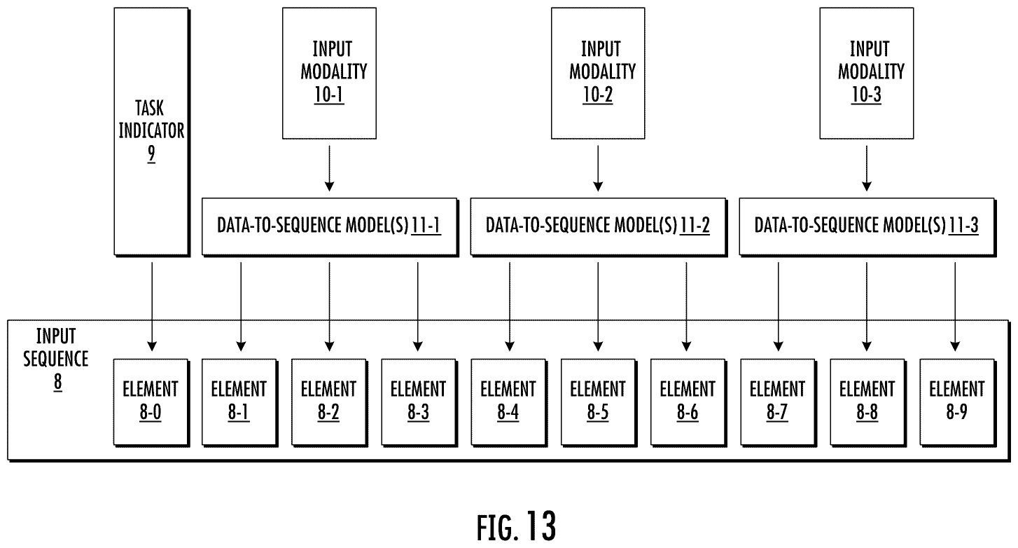

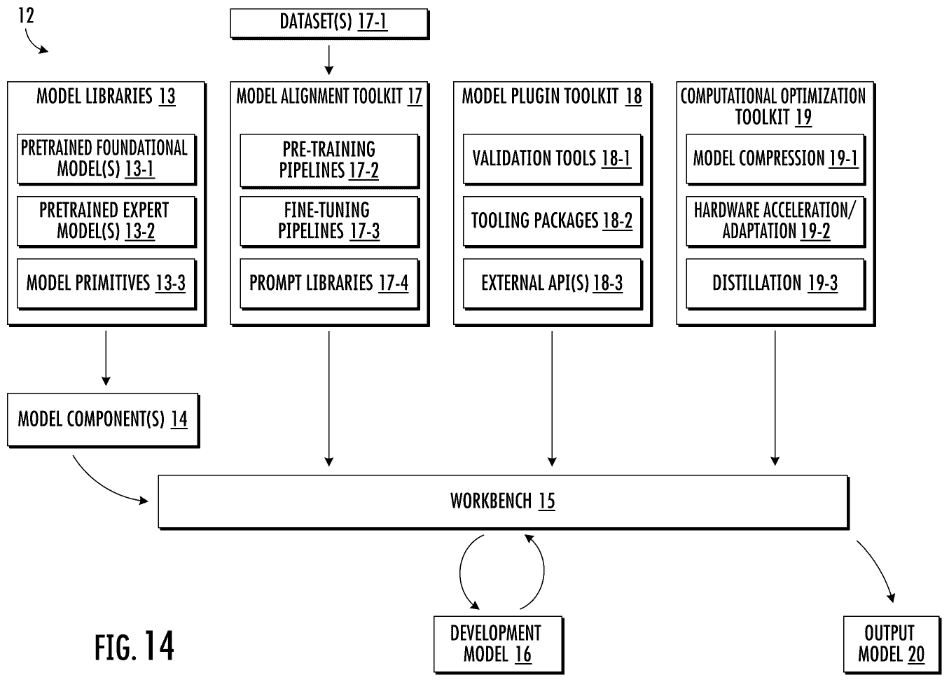

Machine-learned media asset generation pipeline 100 can include an asset feedback layer 140. Asset feedback layer 140 can facilitate input of user feedback on generated assets and initiate generation of updated or different assets. After selection, confirmation, or approval using asset feedback layer 140 (e.g., as depicted in FIG. 12, FIG. 13, and FIG. 14), machine-learned media asset generation pipeline 100 can output media assets 150. Media assets 150 can include any type of media asset output. Media asset output can include, for example text assets, image assets, audio assets, video assets, and/or unique profile data (e.g., brand profile data, color palette, logo).

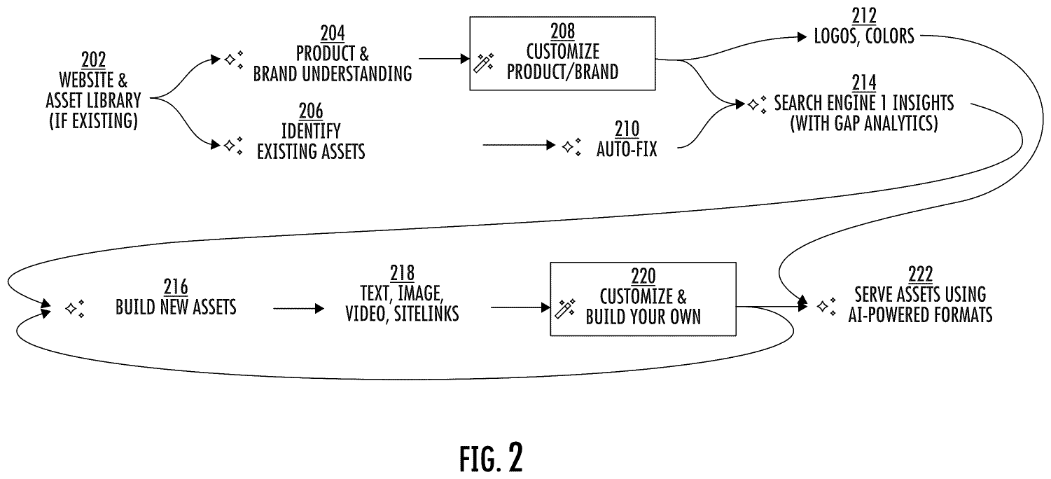

FIG. 2 depicts a flow diagram of an example machine-learned media asset generation pipeline 200 according to example embodiments of the present disclosure. In some instances, the system can receive a website and/or asset library at 202. At 204, the system can determine a product and brand understanding based on the information received and/or obtained at 202. At 206, the system can identify existing assets based on the information received and/or obtained at 202. At 208, the system can customize a product and/or brand based on the determination at 204. At 210, the system can modify (e.g., update) the existing assets that are identified at 206. At 212, the system can determine logos and colors based on the information derived at 208 and/or 210. At 214, the system can determine insights about the company and/or products based on the information derived at 208 and/or 210. At 214, the system can also perform a gap analysis to predict, or auto-generation missing information based on the information derived at 208 and/or 210.

Additionally, at 216, the system can generate new assets based on the information derived at 214. At 218, the system can modify the new asset generated at 216 by adding (e.g., modifying) text, image, videos, and/or sitelinks. The text, image, videos, and/or sitelinks that are selected at 218 can be determined or generated based on information derived at 212 and 214. At 220, the system can receive user input to customize the new assets that are generated at 216 and modified at 218. At 222, the system can serve (e.g., present) the customized assets 220 using AI-powered formats.

The machine-learned media asset generation pipeline 200 can include an overall model. The overall model can be a machine-learned generation model that is configured to generate a plurality of content items. Additionally, or alternatively, the overall model can be a machine-learned selection model that is configured to select a selected content item from the plurality of content items In some implementations, the overall model is trained to receive a set of input data 204 descriptive of a web resource and, as a result of receipt of the input data 204, provide output data 206 that automatically generated new media assets and content items. For example, the system can receive, from a user device of a user, user input associated with a web resource. The system can extract a plurality of assets (e.g., an image, a word, a video, or an audio file) from the web resource. Additionally, the system, using the overall model (e.g., machine-learned generation model), can process the plurality of assets to generate the plurality of content items. Moreover, the system, using the overall model (e.g., a machine-learned selection model), can determine the selected content item from the plurality of content items. Subsequently, the system can cause the presentation of the selected content item on a graphical user interface displayed on the user device.

In another embodiment, the system can receive data indicating a request for a plurality of media assets that comprise multiple media modalities. Additionally, the system can obtain a media asset profile for a client account associated with the request. The media asset profile can include data indicating media asset preferences for the client account, and the media asset profile can be generated by processing pre-existing media assets associated with the client account. The system can generate, using a machine-learned media asset generation pipeline 200, the plurality of media assets based on the media asset profile by instructing an overall model (e.g., machine-learned asset generation model) to generate media assets that align with the media asset preferences. Subsequently, the system can send, based on receiving data indicating selection of one or more of the plurality of media assets, the one or more of the plurality of media assets to a content item generation system for generating content items using the one or more of the plurality of media assets.

According to some embodiments, the system can work alongside a client to curate and create quality, engaging media assets of all kinds for the client's business automatically. Any business, large or small, can start advertising with the system in seconds, even without any assets yet. The system can lower the barrier for all businesses to reach their customers in a personalized and engaging way and democratize advertising creative development for everyone.

The system can combine the best machine learning models, including generative AI, and deep insights to help fill out an entire asset group for most new campaigns automatically in real time. With one click, a client can immediately start with an asset group set to deliver results for client-specific goals, then be able to modify the content items and/or media assets based on suggestions received from the system.

For example, the client can input as much or as little information to generate content items, and as the client generates these content items, the client can in some implementations be able to see the system's assumptions, have the opportunity to make refinements, and accept the media assets (e.g., content items) that the client wants. The client can publish the recommended media assets directly, or just use them as a starting point to customize or build their own.

The system can include a user interface framework for collecting inputs for intelligent asset creation, collection, and combination. The system can surface these assets and the system's assumptions back to clients (e.g., customers). The system can enable refinements of the media assets based on user input, all within the media asset construction process or onboarding flow process.

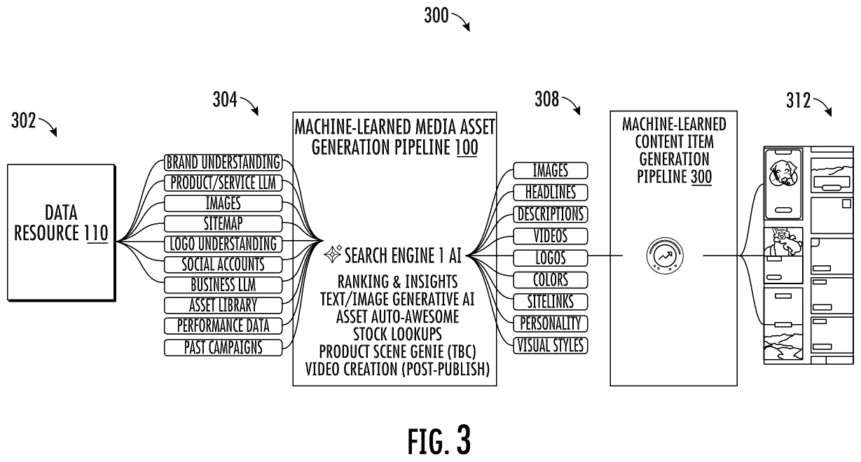

FIG. 3 depicts a block diagram 300 of an example system according to example embodiments of the present disclosure. The system can receive a URL 302 from a user. For example, the system can receive, from a user device of a user, user input associated with the URL. The system can extract a plurality of assets 304 from a data resource 110 associated with the URL 302. The plurality of assets 304 can include brand understanding, product, and service large language model (LLM), images, sitemap, logo understanding, social accounts, business LLM, asset library, performance data, past campaign data. Additionally, the system, machine-learned media asset generation pipeline 100 can process the plurality of assets 304 to generate the plurality of content items 308. The overall model 306 can perform ranking and insights determination, text and/or image generative artificial intelligence, asset auto-generate, stock lockups, product generation, and video creation. The plurality of content 308 can include images, headlines, descriptions, videos, logos, colors, sitelinks, personality, and visual styles. The system can use a machine-learned content item generation pipeline 310 to determine the selected media assets from the plurality of media assets to generate content items 312. Subsequently, the system can cause the presentation of a new content item on a graphical user interface displayed on a user device.

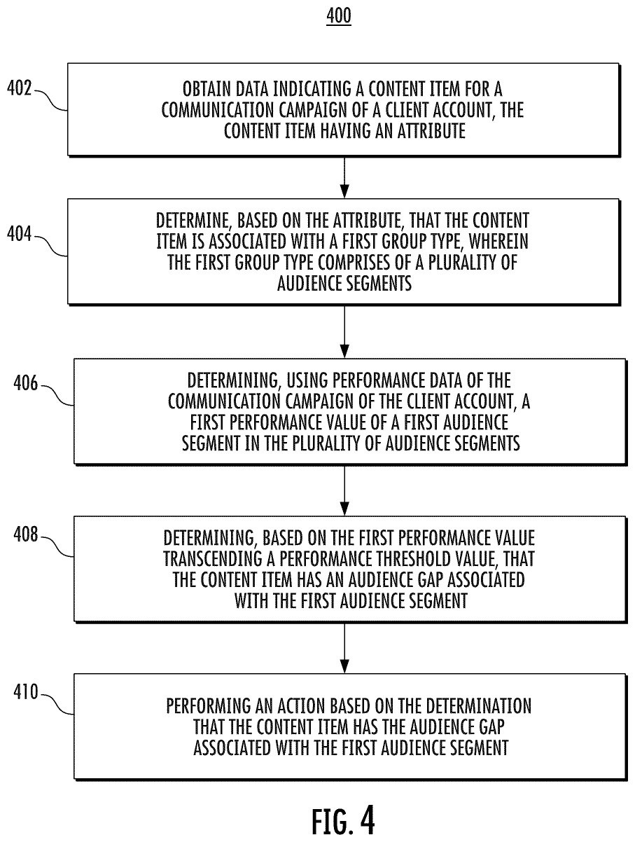

FIG. 4 depicts a flow diagram of an example method 400 for determining an audience asset gap in a communication campaign in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 400 is performed by a server computing system (e.g., server computing system 60) or client computing system (e.g., computing devices 50). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processors can be omitted in various embodiments. Thus, not all processes are required in every embodiment. Other process flows are possible.

At operation 402, the system can obtain data indicating a content item for a communication campaign of a client account, the content item having an attribute. In an example, the content item can be a sponsored content item for a box of chocolate, and the attribute can be a label for the box of chocolate. The attribute can be a label that has been generated for the content item. The attribute can be generated using a machine-learned model. In this example associated with the box of chocolate, example attributes can include be food, chocolate, sweets, gift, and other labels that the machine-learned model has attributed to the box of chocolate.

At operation 404, the system can determine, based on the attribute, that the content item is associated with a first group type. For example, the first group type can be a type of product or service (e.g., running shoes, travel service, vehicle, food). The first group type can include a plurality of audience segments. For example, the plurality of audience segments (e.g., green living enthusiasts, thrill seekers, foodies, recently graduated) can be determined based on a plurality of traffic slices of the communication campaign.

At operation 406, the system can determine, using performance data of the communication campaign of the client account, a first performance value of a first audience segment in the plurality of audience segments. For example, the first performance value can be the CTR or long CTR of the first audience segment, the first audience segment can be users that enjoy food (i.e., food enthusiasts), and the content item can be a sponsored content for a box of chocolate. In this example, a second audience segment can be chocolate lovers.

At operation 408, the system can determine, based on the first performance value transcending a performance threshold value, that the content item has an audience gap associated with the first audience segment. Continuing with the example, the system can determine that the sponsored content for a box of chocolate is not performing well with the first audience segment (e.g., food enthusiasts) but performing well with the second audience segment (e.g., chocolate lovers). The determination can be based on the performance value (e.g., CTR, long CTR, impression rate, impressions) being below a performance threshold value. The performance threshold value can be calculated by aggregating the performance value of past communication campaigns of similar content items with the respective audience segment. For example, similar content can have an average CTR with the first audience segment, and if the performance value of the content item is below the average CTR, then the system can determine that the content item has an audience gap associated with the first audience segment.

At operation 410 the system can perform an action based on the determination that the content item has the audience gap associated with the first audience segment.

In some instances, the method can further include determining, based on performance data of a plurality of similar accounts, a set of features in content items that are presented to the first audience segment. For example, the set of features can be features that have performed well when presented to the first audience segment. In one example, the system can determine that an image of a mountain in the content items for green living enthusiasts results in better performance (e.g., improvement of the CTR). The set of features can improve a performance metric of the content items that are presented to the first audience segment. Moreover, the action performed when determined that the content item has the audience gap can be based on the set of features. For example, the system can determine that images of mountains can improve the CTR for green living enthusiasts, and the action performed can be to modify the content item to include an image of a mountain.

In some instances, the plurality of similar accounts can be determined based on each account in the plurality of similar accounts having a similarity score that exceeds a similarity threshold value. For example, each account in the plurality of similar accounts can have a similarity score that is above the threshold value. The threshold value can be determined by the machine-learned model and can be updated based on user feedback. The similarity score can be derived based on a search query similarity between the client account and the similar account. For example, the client account and the similar account can have a high similarity score if both accounts are associated with the “running” or “walking” keyword search terms.

In some instances, each similar account in plurality of similar accounts have a similar geolocation as the client account.

In some instances, the client account includes a media asset profile. The method can further include comparing a first feature in the set of features and the media asset profile. Additionally, the method can include generating, based on the comparison of the first feature and the media asset profile, a subset of features by removing the first feature from the set of features. Moreover, the action performed when determined that the content item has the audience gap can be based on the subset of features.

In some instances, the comparison of the first feature and the media asset profile includes processing the first feature, using a machine-learned model, to generate feature embeddings. Additionally, the method can include processing assets in the media asset profile, using the machine-learned model, to generate profile embeddings. Moreover, the method can include comparing the feature embeddings and the profile embedding to determine that the first feature does not correspond to assets in the media asset profile. For example, the client account can be associated with travel to the mountains, and the first feature can be an image of a beach. The method can determine that the beach is not associated with the client account and remove this feature from the set of features.

In some instances, the method can include processing a plurality of content items associated with the first group type, using a machine-learned model, to determine the plurality of audience segments. For example, the first group type can be running shoes, and the plurality of audience segments can include athletes, students, elderly, children, and so on. In some instances, a performance value of each audience segment in the plurality of audience segments exceeds a threshold value.

In some instances, the method can include generating, using a machine-learned asset generation pipeline, a suggested asset based on the first audience segment. Additionally, the action performed can include a presentation of the suggested asset on a graphical user interface of the client account. In some instances, the suggested asset is generated when the client account includes an audience segment. For example, if the system determines that the client account is not associated with any audience segment, then the system does not present a suggested asset on the graphical user interface.

In some instances, the client account can include a media asset profile. Additionally, the suggested asset is generated using the machine-learned asset generation pipeline further based on the media asset profile of the client account. For example, the suggested asset can be generated based on a pre-existing asset associated with the client account. The pre-existing asset can be previously uploaded to the client account.

In some instances, the method can include processing the suggested asset and the first audience segment, using a machine-learned estimation model, to determine an uplift estimation value. Additionally, the action performed further includes the presentation of the uplift estimation value on the graphical user interface.

In some instances, the machine-learned estimation model can be trained on performance data of a plurality of similar accounts.

In some instances, the first performance value can be a click-through rate, and the threshold value can be an average click-through rate for the first audience segment.

In some instances, the first group can be a type of product.

In some instances, the content item can be currently being served in the communication campaign.

In some instances, method 400 can further include obtaining past performance data of content items that are associated with a plurality of account that are similar to the client account. For example, the client account can be a shoe company, and the plurality of accounts that are similar can be accounts of other shoe companies. Additionally, the performance threshold value that is calculated at operation 406 can be based on the past performance data of content items that are associated with the plurality of account that are similar to the client account.

In some instances, method 400 can further include obtaining past performance data of content items that are associated with the first group type. Additionally, the performance threshold value that is calculated at operation 406 can be based on the past performance data of content items that are associated with the first group type.

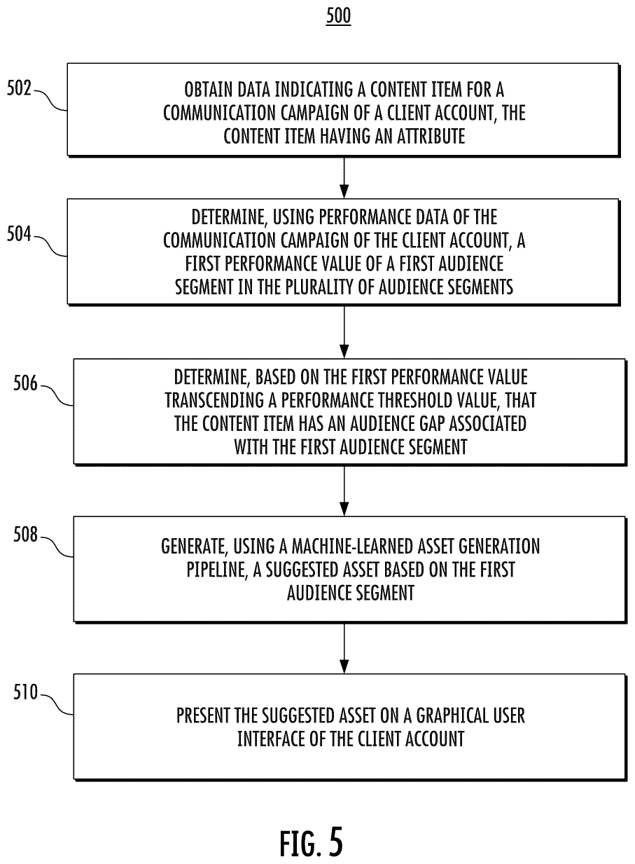

FIG. 5 depicts a flow diagram of an example method 500 for determining an audience asset gap and generating a suggested asset for the audience gap in accordance with some embodiments of the present disclosure. The suggested asset can be generated based on techniques described in FIGS. 1-3. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 500 is performed by a server computing system (e.g., server computing system 60) or client computing system (e.g., computing devices 50). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processors can be omitted in various embodiments. Thus, not all processes are required in every embodiment. Other process flows are possible.

At operation 502, the system can obtain data indicating a content item for a communication campaign of a client account, the content item having an attribute.

At operation 504, the system can determine, using performance data of the communication campaign of the client account, a first performance value of a first audience segment in the plurality of audience segments. For example, the first performance value can be the CTR or long CTR of the first audience segment.

At operation 506, the system can determine, based on the first performance value transcending a performance threshold value, that the content item has an audience gap associated with the first audience segment. The performance threshold value can be calculated by aggregating the performance value of past communication campaigns of similar content items with the respective audience segment. For example, similar content can have an average CTR with the first audience segment, and if the performance value of the content item is below the average CTR, then the system can determine that the content item has an audience gap associated with the first audience segment.

At operation 508, the system can generate, using a machine-learned asset generation pipeline, a suggested asset based on the first audience segment. The machine-learned asset generation pipeline can be the machine-learned media asset generation pipeline 100 in FIG. 1.

At operation 510, the system can present the suggested asset on a graphical user interface of the client device.

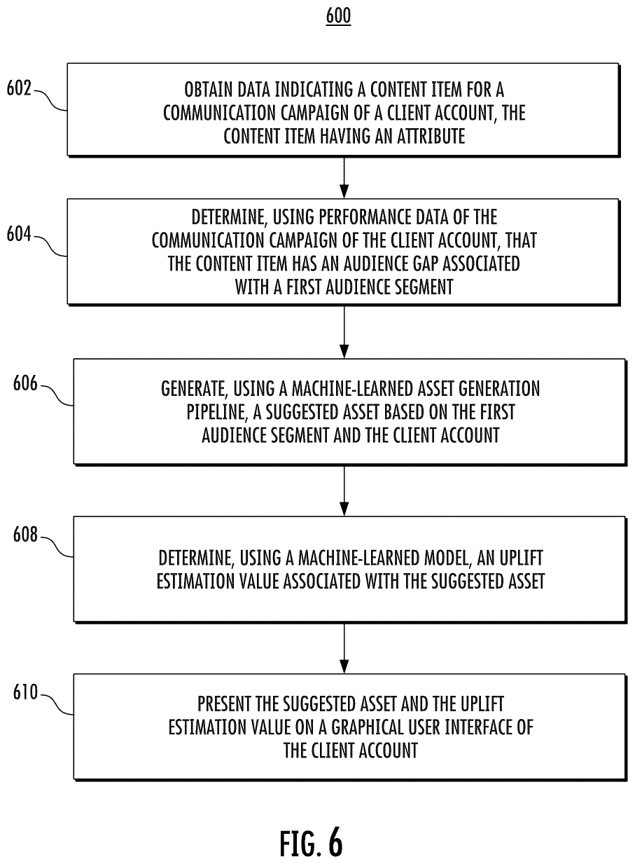

FIG. 6 depicts a flow diagram of an example method 600 for generating a suggested asset for the audience gap and calculating an uplift estimate value for the suggested asset in accordance with some embodiments of the present disclosure. The suggested asset can be generated based on techniques described in FIGS. 1-3. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 600 is performed by a server computing system (e.g., server computing system 60) or client computing system (e.g., computing devices 50). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processors can be omitted in various embodiments. Thus, not all processes are required in every embodiment. Other process flows are possible.

At operation 602, the system can obtain data indicating a content item for a communication campaign of a client account, the content item having an attribute.

At operation 604, the system can determine, using performance data of the communication campaign of the client account, that the content item has an audience gap associated with a first audience.

At operation 606, the system can generate, using a machine-learned asset generation pipeline, a suggested asset based on the first audience segment and information obtained (e.g., derived) from the client account. The machine-learned asset generation pipeline can be the machine-learned media asset generation pipeline 100 in FIG. 1.

At operation 608, the system can determine an uplift estimation value associated with presenting the suggested asset in the communication campaign.

At 610, the system can present the suggested asset and the uplift estimation value on a graphical user interface of the client device.

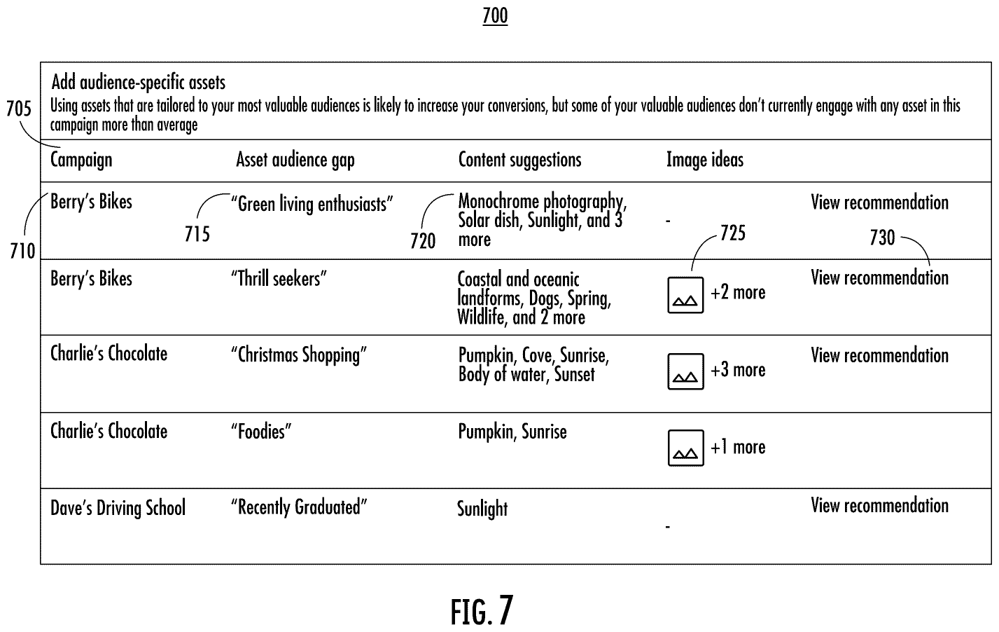

FIG. 7 depicts an example graphical user interface 700 from a communication campaign platform of a client account. The graphical user interface 800 can include a plurality of campaigns 705. Additionally, the first campaign 710 in the plurality of campaigns 705 can have an asset audience gap 715. The system can also present a content suggestion 720 for this asset audience gap. In some instances, the system can also generate a suggested asset 725 (e.g., image asset) and present a recommendation 730.

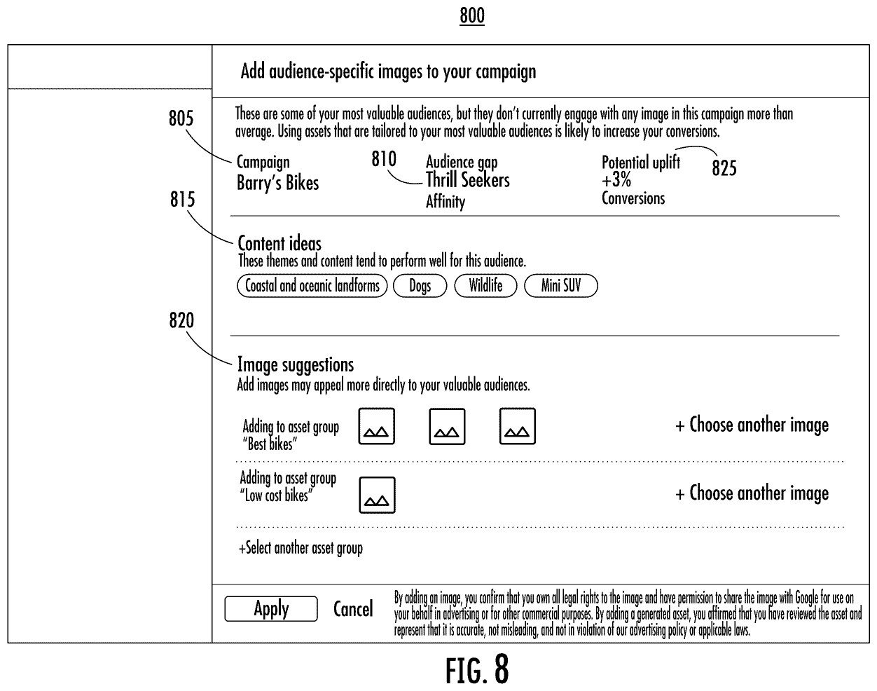

FIG. 8 depicts another example graphical user interface 800 from a communication campaign platform of a client account. The graphical user interface 800 allows a user of the client account to add audience specific images to the communication campaign. In this example, a first communication campaign 805 titled “Barry's Bikes” has an audience gap 810 with thrill seekers. The system can present content ideas 815 associated with the audience gap. Additionally, the system can present suggested asset 820 associated with the audience gap. Moreover, the system can present an estimation uplift value 825 if the user utilizes the suggested asset 820 in a communication campaign. In this example, the system estimates a 3% improvement in conversions for the audience gap when the communication campaign includes the suggested asset.

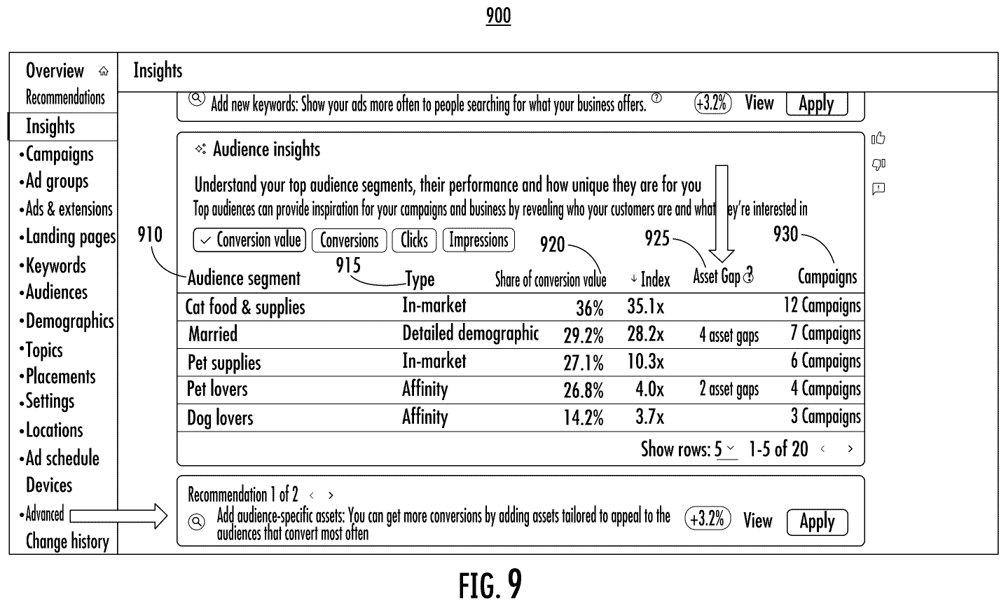

FIG. 9 depicts another example graphical user interface 900 from a communication campaign platform of a client account. In this example, the system can present a plurality of audience segments 910, a type 915 associated with the audience segment, a performance value 920 (e.g., conversion value, conversions, clicks, impressions) associated with the audience segment, an asset gap 925 associated with the audience segment, and the number of communication campaigns associated the audience segment.

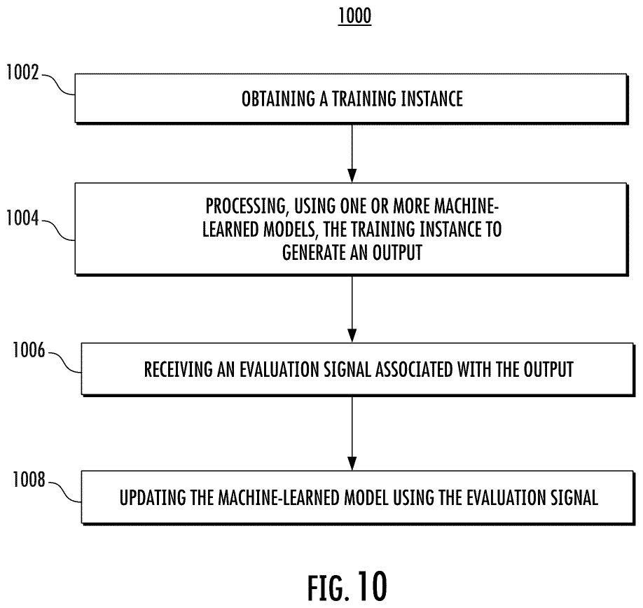

FIG. 10 depicts a flowchart of a method 1000 for training one or more machine-learned models according to aspects of the present disclosure. For instance, an example machine-learned model can include machine-learned media asset generation pipeline, machine-learned content item generation pipeline, a machine-learned text generator, a machine-learned image generator, a machine-learned audio generator, and a machine-learned video generator.

One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be back propagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

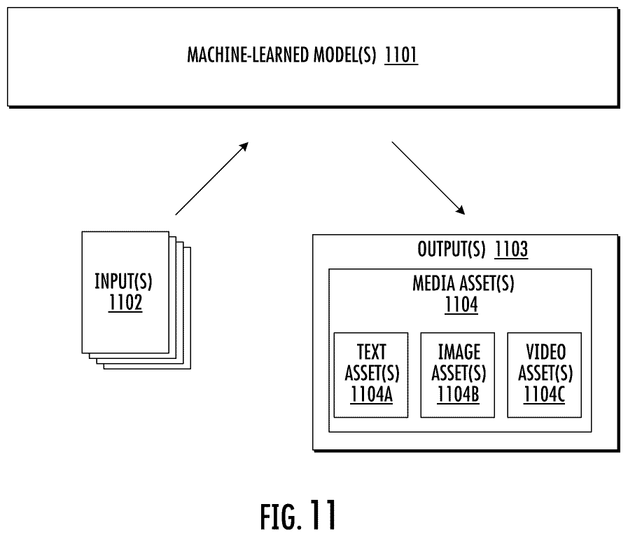

FIG. 11 is a block diagram of an example processing flow for using machine-learned model(s) 1101 to process input(s) 1102 to generate output(s) 1103.

Machine-learned model(s) 1101 can be or include one or multiple machine-learned models or model components. For instance, machine-learned model(s) 1101 can include machine-learned media asset generation model 1101A and/or machine-learned content item generation model 1101B. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1101 can include a single or multiple instances of the same model configured to operate on data from input(s) 1102. Machine-learned model(s) 1101 can include an ensemble of different models that can cooperatively interact to process data from input(s) 1102. For example, machine-learned model(s) 1101 701 can employ a mixture-of-experts structure.

Input(s) 1102 can generally include or otherwise represent various types of data. Input(s) 1102 can include one type or many different types of data. For instance, inputs can include existing media asset(s) 1102A (e.g., existing content items) and/or data resources 1102B. Output(s) 1103 can be data of the same type(s) or of different types of data as compared to input(s) 1102. Output(s) 1103 can include one type or many different types of data. For instance, output(s) 1103 can include media asset(s) 1104 and/or content item(s) 1105. Media asset(s) 1104 can include, for example, text asset(s) 1104A, image asset(s) 1104B, and/or unique profile data 1104C.

Example data types for input(s) 1102 or output(s) 1103 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 1102 or outputs 1103, example combinations of data types include image data and audio data, image data and natural language data, natural language data and software code data, image data and biometric data, sensor data and medical data, etc. It is to be understood that any combination of data types in an input 1102 or an output 1103 can be present.

An example input 1102 can include one or multiple data types, such as the example data types noted above. An example output 1103 can include one or multiple data types, such as the example data types noted above. The data type(s) of input 1102 can be the same as or different from the data type(s) of output 1103. It is to be understood that the example data types noted above are provided for illustrative purposes only. Data types contemplated within the scope of the present disclosure are not limited to those examples noted above.

FIG. 12 is a block diagram of an example implementation of an example machine-learned model configured to process sequences of information. For instance, an example implementation of machine-learned model(s) 1101 can include machine-learned sequence processing model(s) 4. An example system can pass input(s) 1102 to sequence processing model(s) 4. Sequence processing model(s) 4 can include one or more machine-learned components. Sequence processing model(s) 4 can process the data from input(s) 1102 to obtain an input sequence 5. Input sequence 5 can include one or more input elements 5-1, 5-2, . . . , 5-M, etc. obtained from input(s) 1102. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 1103 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 1102. For instance, input sequence 5 can include a representation of data from input(s) 1102 in a format understood by sequence processing model(s) 4. One or more machine-learned components of sequence processing model(s) 4 can ingest the data from input(s) 1102, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 1102 and parse the data into a sequence of elements to obtain input sequence 5. For example, a portion of input data from input(s) 1102 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other.

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 1102 and output(s) 1103).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

FIG. 14 is a block diagram of an example model development platform 12 that can facilitate creation, adaptation, and refinement of example machine-learned models (e.g., machine-learned model(s) 1101, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without examples in the inputs. For instance, zero-shot prompts can include inputs that lack examples. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

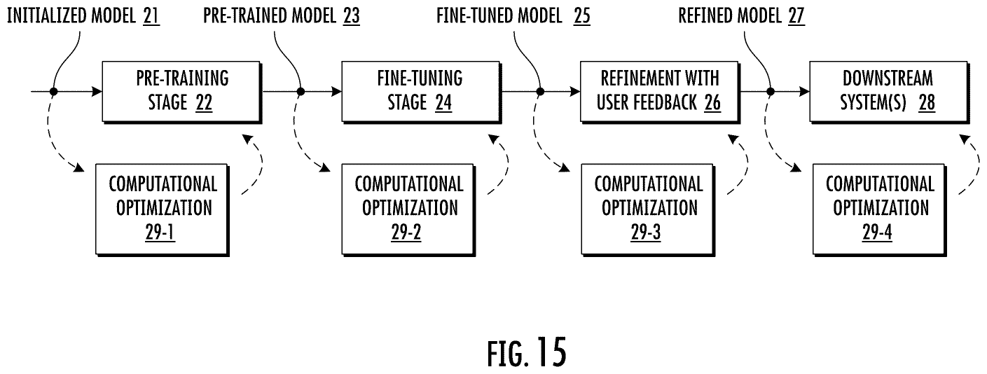

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 21 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 21 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

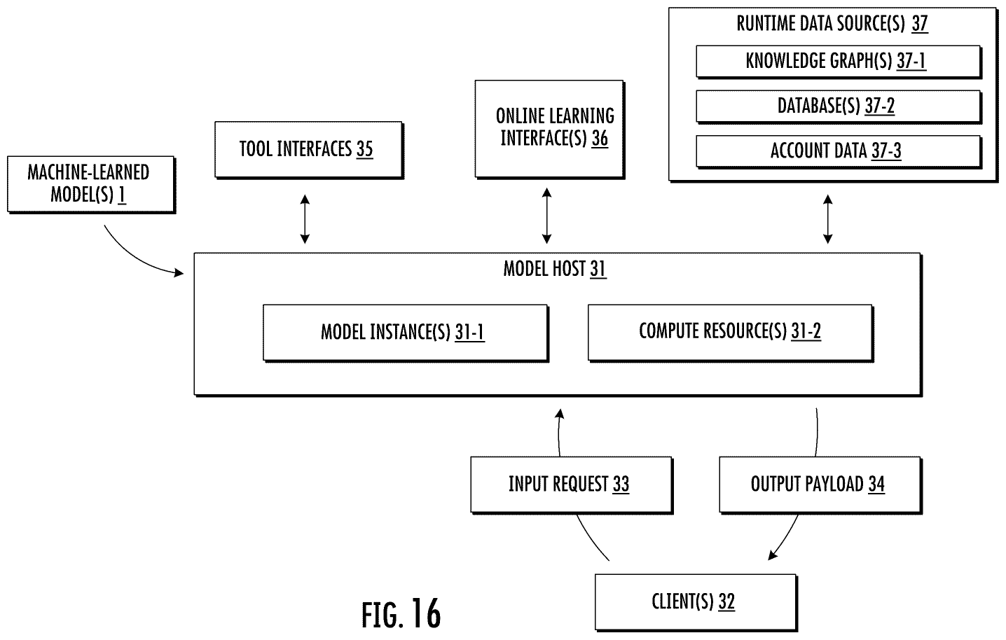

FIG. 16 is a block diagram of an inference system for operating one or more machine-learned model(s) 1101 to perform inference (e.g., for training, for deployment, etc.). A model host 31 can receive machine-learned model(s) 1101. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 1102 for input to machine-learned model(s) 1101. Machine-learned model(s) 1 can process input(s) 1102 to generate output(s) 1103. Using output(s) 1103, model host 31 can return an output payload 34 for responding to input request 33 from client(s) 32. Output payload 34 can include or be based on output(s) 1103.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1101. For instance, online learning interface(s) 36 can be used within reinforcement learning loops to retrieve user feedback on inferences served by model host 31. Model host 31 can access runtime data source(s) 37 for augmenting input(s) 1102 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 1102. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 1102. Model host 31 can process input request 33 to obtain input(s) 1102. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 1102 can be distributed across the batch dimension (e.g., rows of an array). The separate input(s) 1102 can include completely different contexts. The separate input(s) 1102 can be multiple inference steps of the same task. The separate input(s) 1102 can be staggered in an input structure, such that any given inference cycle can be operating on different portions of the respective input(s) 1102. In this manner, for instance, model host 31 can perform inference on the batch in parallel, such that output(s) 1103 can also contain the batch dimension and return the inference results for the batched input(s) 1102 in parallel. In this manner, for instance, batches of input request(s) 33 can be processed in parallel for higher throughput of output payload(s) 34.

Output payload 34 can include or be based on output(s) 1103 from machine-learned model(s) 1101. Model host 31 can process output(s) 1103 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1101. Online learning interface(s) 36 can facilitate reinforcement learning with human feedback (RLHF). Online learning interface(s) 36 can facilitate federated learning of machine-learned model(s) 1101.

Model host 31 can execute machine-learned model(s) 1101 to perform inference for various tasks using various types of data. For example, various different input(s) 1102 and output(s) 1103 can be used for various different tasks. In some implementations, input(s) 1102 can be or otherwise represent image data. Machine-learned model(s) 1 can process the image data to generate an output. As an example, machine-learned model(s) 1101 can process the image data to generate an image recognition output (e.g., a recognition of the image data, a latent embedding of the image data, an encoded representation of the image data, a hash of the image data, etc.). As another example, machine-learned model(s) 1101 can process the image data to generate an image segmentation output. As another example, machine-learned model(s) 1101 can process the image data to generate an image classification output. As another example, machine-learned model(s) 1101 can process the image data to generate an image data modification output (e.g., an alteration of the image data, etc.). As another example, machine-learned model(s) 1101 can process the image data to generate an encoded image data output (e.g., an encoded and/or compressed representation of the image data, etc.). As another example, machine-learned model(s) 1101 can process the image data to generate an upscaled image data output. As another example, machine-learned model(s) 1101 can process the image data to generate a prediction output.

In some implementations, the task is a computer vision task. In some cases, input(s) 1102 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 1102 can be or otherwise represent natural language data. Machine-learned model(s) 1 can process the natural language data to generate an output. As an example, machine-learned model(s) 1101 can process the natural language data to generate a language encoding output. As another example, machine-learned model(s) 1101 can process the natural language data to generate a latent text embedding output. As another example, machine-learned model(s) 1101 can process the natural language data to generate a translation output. As another example, machine-learned model(s) 1101 can process the natural language data to generate a classification output. As another example, machine-learned model(s) 1101 can process the natural language data to generate a textual segmentation output. As another example, machine-learned model(s) 1101 can process the natural language data to generate a semantic intent output. As another example, machine-learned model(s) 1101 can process the natural language data to generate an upscaled text or natural language output (e.g., text or natural language data that is higher quality than the input text or natural language, etc.). As another example, machine-learned model(s) 1101 can process the natural language data to generate a prediction output (e.g., one or more predicted next portions of natural language content).

In some implementations, input(s) 1102 can be or otherwise represent speech data (e.g., data describing spoken natural language, such as audio data, textual data, etc.). Machine-learned model(s) 1 can process the speech data to generate an output. As an example, machine-learned model(s) 1101 can process the speech data to generate a speech recognition output. As another example, machine-learned model(s) 1101 can process the speech data to generate a speech translation output. As another example, machine-learned model(s) 1101 can process the speech data to generate a latent embedding output. As another example, machine-learned model(s) 1101 can process the speech data to generate an encoded speech output (e.g., an encoded and/or compressed representation of the speech data, etc.). As another example, machine-learned model(s) 1101 can process the speech data to generate an upscaled speech output (e.g., speech data that is higher quality than the input speech data, etc.). As another example, machine-learned model(s) 1101 can process the speech data to generate a textual representation output (e.g., a textual representation of the input speech data, etc.). As another example, machine-learned model(s) 1101 can process the speech data to generate a prediction output.

In some implementations, input(s) 1102 can be or otherwise represent latent encoding data (e.g., a latent space representation of an input, etc.). Machine-learned model(s) 1 can process the latent encoding data to generate an output. As an example, machine-learned model(s) 1101 can process the latent encoding data to generate a recognition output. As another example, machine-learned model(s) 1101 can process the latent encoding data to generate a reconstruction output. As another example, machine-learned model(s) 1101 can process the latent encoding data to generate a search output. As another example, machine-learned model(s) 1101 can process the latent encoding data to generate a reclustering output. As another example, machine-learned model(s) 1101 can process the latent encoding data to generate a prediction output.

In some implementations, input(s) 1102 can be or otherwise represent statistical data. Statistical data can be, represent, or otherwise include data computed and/or calculated from some other data source. Machine-learned model(s) 1 can process the statistical data to generate an output. As an example, machine-learned model(s) 1101 can process the statistical data to generate a recognition output. As another example, machine-learned model(s) 1101 can process the statistical data to generate a prediction output. As another example, machine-learned model(s) 1101 can process the statistical data to generate a classification output. As another example, machine-learned model(s) 1101 can process the statistical data to generate a segmentation output. As another example, machine-learned model(s) 1101 can process the statistical data to generate a visualization output. As another example, machine-learned model(s) 1101 can process the statistical data to generate a diagnostic output.

In some implementations, input(s) 1102 can be or otherwise represent sensor data. Machine-learned model(s) 1 can process the sensor data to generate an output. As an example, machine-learned model(s) 1101 can process the sensor data to generate a recognition output. As another example, machine-learned model(s) 1101 can process the sensor data to generate a prediction output. As another example, machine-learned model(s) 1101 can process the sensor data to generate a classification output. As another example, machine-learned model(s) 1101 can process the sensor data to generate a segmentation output. As another example, machine-learned model(s) 1101 can process the sensor data to generate a visualization output. As another example, machine-learned model(s) 1101 can process the sensor data to generate a diagnostic output. As another example, machine-learned model(s) 1101 can process the sensor data to generate a detection output.

In some implementations, machine-learned model(s) 1101 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1101 can be configured to output content generated in view of input(s) 1102. For instance, input(s) 1102 can be or otherwise represent data of one or more modalities that encodes context for generating additional content.

In some implementations, the task can be a text completion task. Machine-learned model(s) 1 can be configured to process input(s) 1102 that represent textual data and to generate output(s) 1103 that represent additional textual data that completes a textual sequence that includes input(s) 1102. For instance, machine-learned model(s) 1101 can be configured to generate output(s) 1103 to complete a sentence, paragraph, or portion of text that follows from a portion of text represented by input(s) 1102.

In some implementations, the task can be an instruction following task. Machine-learned model(s) 1 can be configured to process input(s) 1102 that represent instructions to perform a function and to generate output(s) 1103 that advance a goal of satisfying the instruction function (e.g., at least a step of a multi-step procedure to perform the function). Output(s) 3 can represent data of the same or of a different modality as input(s) 1102. For instance, input(s) 1102 can represent textual data (e.g., natural language instructions for a task to be performed) and machine-learned model(s) 1101 can process input(s) 1102 to generate output(s) 1103 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1101 can process input(s) 1102 to generate output(s) 1103 that represent textual data responsive to the instructions (e.g., natural language responses, programming language responses, machine language responses, etc.). One or more output(s) 1103 can be iteratively or recursively generated to sequentially process and accomplish steps toward accomplishing the requested functionality. For instance, an initial output can be executed by an external system or be processed by machine-learned model(s) 1101 to complete an initial step of performing a function. Multiple steps can be performed, with a final output being obtained that is responsive to the initial instructions.

In some implementations, the task can be a question answering task. Machine-learned model(s) 1 can be configured to process input(s) 1102 that represent a question to answer and to generate output(s) 1103 that advance a goal of returning an answer to the question (e.g., at least a step of a multi-step procedure to perform the function). Output(s) 3 can represent data of the same or of a different modality as input(s) 1102. For instance, input(s) 1102 can represent textual data (e.g., natural language instructions for a task to be performed) and machine-learned model(s) 1101 can process input(s) 1102 to generate output(s) 1103 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1101 can process input(s) 1102 to generate output(s) 1103 that represent textual data responsive to the question (e.g., natural language responses, programming language responses, machine language responses, etc.). One or more output(s) 1103 can be iteratively or recursively generated to sequentially process and accomplish steps toward answering the question. For instance, an initial output can be executed by an external system or be processed by machine-learned model(s) 1101 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 1102 that represent context regarding a desired portion of image content. The context can include text data, image data, audio data, etc. Machine-learned model(s) 1 can be configured to generate output(s) 1103 that represent image data that depicts imagery related to the context. For instance, machine-learned model(s) 1101 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 1102 that represent context regarding a desired portion of audio content. The context can include text data, image data, audio data, etc. Machine-learned model(s) 1 can be configured to generate output(s) 1103 that represent audio data related to the context. For instance, machine-learned model(s) 1101 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 1102 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 1103 that represent data that aligns with the desired data. For instance, machine-learned model(s) 1101 can be configured to generate data values for populating a dataset. Values for the data object(s) can be selected based on the context (e.g., based on a probability determined based on the context).

FIG. 16 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 23 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1101, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1101, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or intraoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1101, 4, 16, 20, 55, 65, etc. (e.g., third-party resource(s) 85).

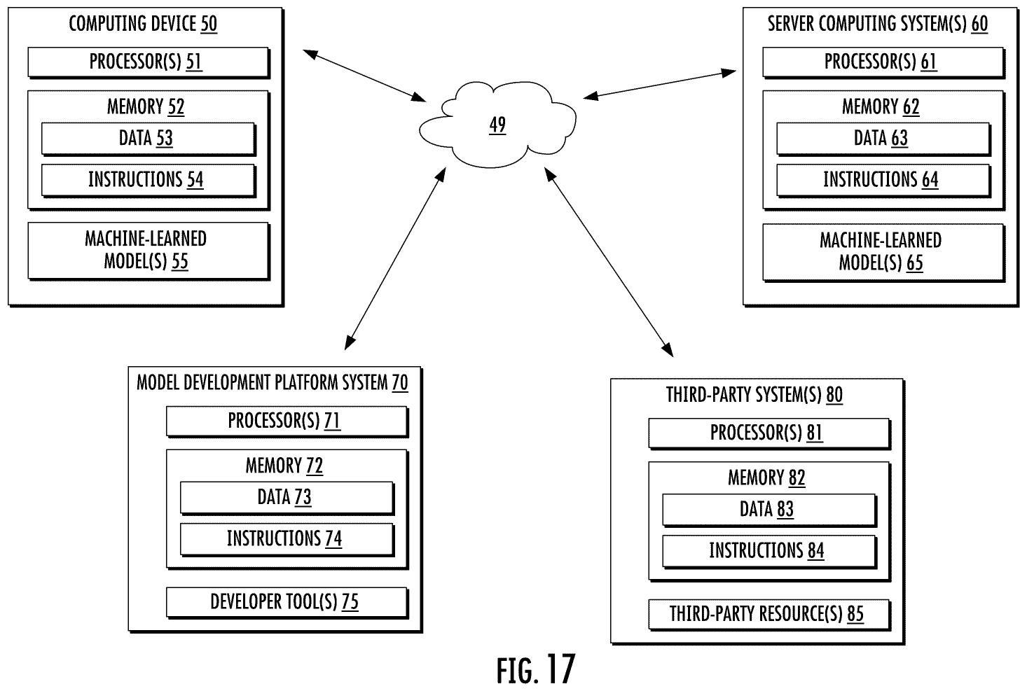

FIG. 17 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

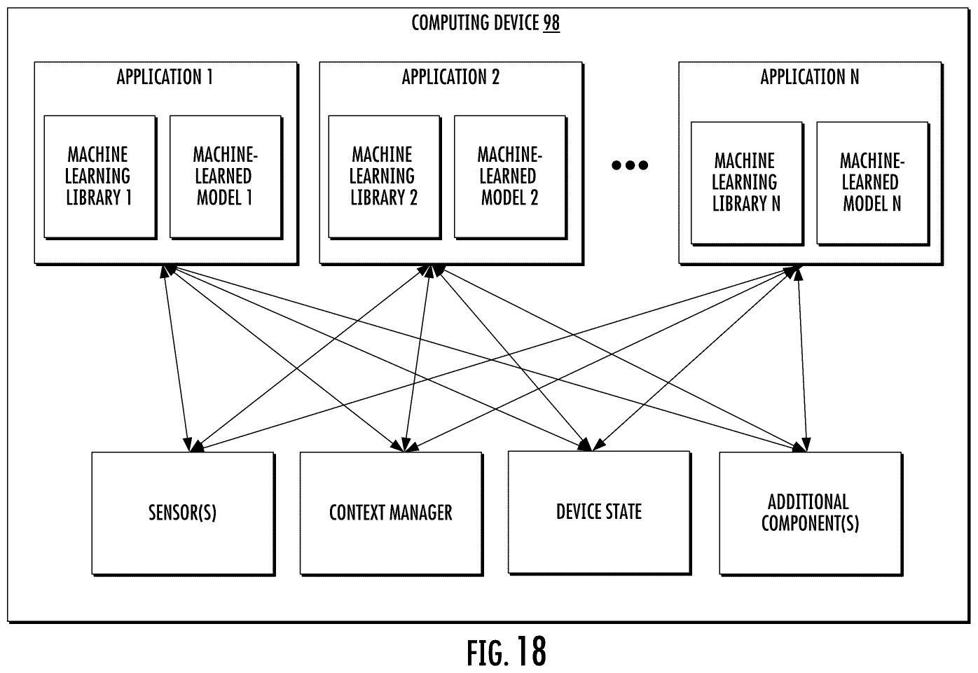

FIG. 18 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 24, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

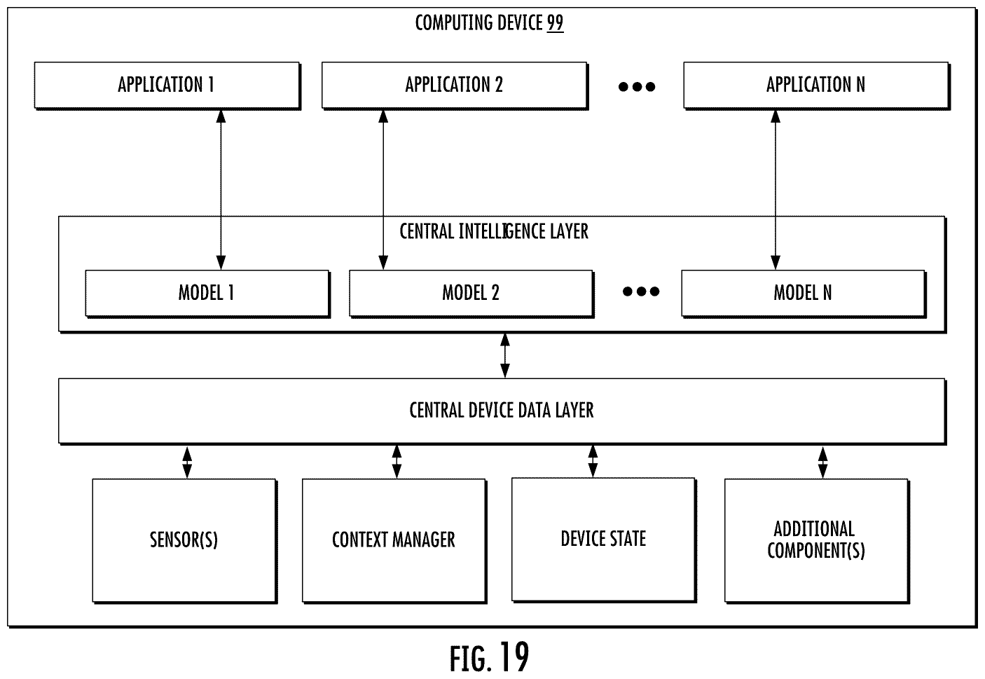

FIG. 19 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 25, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 25, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
obtaining data indicating a content item for a communication campaign of a client account, the content item having an attribute;
determining, based on the attribute, that the content item is associated with a first group type, wherein the first group type comprises of a plurality of audience segments;
determining, using performance data of the communication campaign of the client account, a first performance value of a first audience segment in the plurality of audience segments;
determining, based on the first performance value transcending a performance threshold value, that the content item has an audience gap associated with the first audience segment; and
performing an action based on the determination that the content item has the audience gap associated with the first audience segment.

2. The method of claim 1, the method further comprising:
determining, based on performance data of a plurality of similar accounts, a set of features in content items that are presented to the first audience segment, wherein the set of features improves a performance metric of the content items that are presented to the first audience segment, and
wherein the action performed is further based on the set of features.

3. The method of claim 2, wherein a similar account in the plurality of similar accounts has a similarity score that exceeds a similarity threshold value, the similarity score being derived based on a search query similarity between the client account and the similar account.

4. The method of claim 2, wherein each similar account in plurality of similar accounts have a similar geolocation as the client account.

5. The method of claim 2, wherein the client account includes a media asset profile, the method further comprising:
comparing a first feature in the set of features and the media asset profile; and
generating, based on the comparing of the first feature and the media asset profile, a subset of features by removing the first feature from the set of features, and
wherein the action performed is based on the subset of features.

6. The method of claim 5, wherein the comparing of the first feature and the media asset profile includes:
processing the first feature, using a machine-learned model, to generate feature embeddings;
processing assets in the media asset profile, using the machine-learned model, to generate profile embeddings; and
comparing the feature embeddings and the profile embedding to determine that the first feature does not correspond to assets in the media asset profile.

7. The method of claim 1, further comprising:
processing a plurality of content items associated with the first group, using a machine-learned model, to determine the plurality of audience segments, a performance value of each audience segment in the plurality of audience segments exceeds a threshold value.

8. The method of claim 1, the method further comprising:
generating, using a machine-learned asset generation pipeline, a suggested asset based on the first audience segment, and
wherein the action performed includes a presentation of the suggested asset on a graphical user interface of the client account.

9. The method of claim 8, wherein the client account includes a media asset profile, and wherein the suggested asset is generated using the machine-learned asset generation pipeline further based on the media asset profile of the client account.

10. The method of claim 8, wherein the suggested asset is generated based on a pre-existing asset associated with the client account, the pre-existing asset having been previously uploaded to the client account.

11. The method of claim 8, the method further comprising:
processing the suggested asset and the first audience segment, using a machine-learned estimation model, to determine an uplift estimation value, and
wherein the action performed further includes the presentation of the uplift estimation value on the graphical user interface.

12. The method of claim 11, wherein the machine-learned estimation model being trained on performance data of previously presented content items of another account.

13. The method of claim 1, wherein the first performance value is a click-through rate, and the threshold value is an average click-through rate for the first audience segment.

14. The method of claim 1, wherein the first group being a type of product, and wherein the content item is currently being served in the communication campaign.

15. The method of claim 1, wherein the plurality of audience segments is determined based on a conversion rate for content items that are associated with the attribute.

16. The method of claim 1, the method further comprising:
determining the plurality of audience segments for the communication campaign based on the attribute of the content item, wherein each audience segment in the plurality of audience segments is associated with the attribute.

17. The method of claim 1, the method further comprising:
obtaining past performance data of content items that are associated with the first group type, and
wherein the performance threshold value is calculated based on the past performance data of content items that are associated with the first group type.

18. The method of claim 1, the method further comprising:
obtaining past performance data of content items that are associated with a plurality of accounts that are similar to the client account, and
wherein the performance threshold value is calculated based on the past performance data of content items that are associated with the plurality of account that are similar to the client account.

19. The method of claim 1, the method further comprising:
obtaining a plurality of content items that are associated with the first group type; and
determining, based the first audience segment, a set of features in content items that are presented to the first audience segment, wherein the set of features improves a performance metric of the content items that are presented to the first audience segment; and
generating, based the set of features and the plurality of content items that are associated with the first group type, a subset of features by removing a first feature from the set of features, and wherein the plurality of content items do not include the first feature.

20. A computing system comprising:
one or more processors; and
one or more transitory or non-transitory computer-readable media storing instructions that are executable to cause the one or more processors to perform operations, the operations comprising:
obtaining data indicating a content item for a communication campaign of a client account, the content item having an attribute;
determining, based on the attribute, that the content item is associated with a first group type, wherein the first group type comprises of a plurality of audience segments;
determining, using performance data of the communication campaign of the client account, a first performance value of a first audience segment in the plurality of audience segments;
determining, based on the first performance value transcending a performance threshold value, that the content item has an audience gap associated with the first audience segment; and
performing an action based on the determination that the content item has the audience gap associated with the first audience segment.

21. One or more non-transitory, computer readable media storing instructions that are executable by one or more processors to cause a computing system to perform operations, the operations comprising:
obtaining data indicating a content item for a communication campaign of a client account, the content item having an attribute;
determining, based on the attribute, that the content item is associated with a first group type, wherein the first group type comprises of a plurality of audience segments;
determining, using performance data of the communication campaign of the client account, a first performance value of a first audience segment in the plurality of audience segments;
determining, based on the first performance value transcending a performance threshold value, that the content item has an audience gap associated with the first audience segment; and
performing an action based on the determination that the content item has the audience gap associated with the first audience segment.
